(19) United States
(12) Patent Application Publication
(10) Pub. No.: US 2016/0142621 A1
(43) Pub. Date: May 19, 2016

(54) DEVICE AND METHOD FOR CAMERA CONTROL

(71) Applicant: ELECTRIC FRIENDS AS, Oslo (NO)

(72) Inventor: Anders TOMREN, Oslo (NO)

(21) Appl. No.: 14/785,258

(22) PCT Filed: Apr. 17, 2014
(86) PCT No.: PCT/EP2014/057901

§ 371 Date: Oct. 16, 2015

(30) Foreign Application Priority Data
Apr. 19, 2013 (NO) 20130551

(51) Int. Cl. H04N 5/232; H04N 5/225

(52) U.S. Cl. CPC H04N 5/23216; H04N 5/23203; H04N 5/23296; H04N 5/2253

(57) ABSTRACT

The present embodiments relate to an intuitive touch-screen control system with a multi-touch user interface for movement of film, video and still cameras in three axes, X, Y, Z, with industrial robots.

### TECHNICAL FIELD

The present embodiment relates to a control device having a display adapted to control the position and/or angle of a camera. The control device comprise of a display based multi-touch control system for cameras mounted on a robotic arm.

### BACKGROUND

Live TV technology began with analog TV signals without graphics, but has now moved over to digital broadcasting in HD (High Definition). This technology is used to broadcast, among other, sports and news events in real time by transmitting a video and audio signal of the event over broadcasting media while the event itself takes place.

A large group of operators is necessary to control the production system in the production of such digital broadcasts, including directors and several technicians.

Modern television broadcasts has therefore become very complicated and expensive, especially with the transition to full HD broadcasts. Moreover, with new technology, new advertising models and rising cost, a continual need for alternative TV technologies arise for production of broadcast content in a more efficient manner.

In photography, film and television production the camera operator/photographer is physically responsible for the image view, distance, angles and composition in choice of image.

The need to produce cheaper photo, film and television with less staffing has in recent years been the main motivation for automating productions.

The camera systems currently used in remote television production is mainly dominated by one type. (Telemetric, Vinten/Radamec).

In a camera system of such a type, the camera is typically mounted on a pan/tilt holder that sits on a “dolly”, i.e. a camera carriage, or mounted on a lifting column with wheels, or mounted on rails on the floor or the ceiling.

The camera can then make pan-/tilt motions, i.e. pan and/or tilt, and move along the rails if the camera is mounted on motorized carts that go on rails. These cameras can store preset image positions that can be retrieved during production.

These systems have limited movement patterns. Adjusting the camera and view for storing images is done by operating two joysticks that require significant training to use.

U.S. Pat. No. 6,973,200 discloses an image processing device that comprises a generation unit that generates a map. The map has a camera icon that indicates the position of an installed camera. The device further comprises a control unit that controls the camera that corresponds to the camera symbol on the map in response to an operation of the camera symbol.

U.S. 2005/0007553 describes a system to compensate pan and tilt of a camera relative to the motions of the camera support structure. The camera support structure may be a dolly, a vehicle, a camera vehicle, an off-road vehicle, a surfboard, a robotic device etc.

Hence, there is a need for an improved system for producing live TV programs that are more effective, less costly, easier to manufacture and able to change and adapt to new requirements for different broadcasts.

### SUMMARY

A control device having a display adapted to control a camera's position and/or angle, where the camera is adapted to be mounted on a movable mechanical device, wherein the control device comprises:
a real-time image view recorded by the camera on the display,
a graphical layer overlaid on the image on the display including at least one camera symbol where the position and/or angle of the camera symbol on the display corresponds to the position and/or angle of the camera,
wherein a change of the position and/or angle of the camera symbol on the display activates a corresponding change of the position and/or angle of the camera,

The mechanically movable device may be a robotic device adapted to being able to move the camera in all spatial directions and angles within a certain range.

The change of a camera symbol position and/or angle can generate signals of the control device sent to the robotic device and is interpreted as instructions of the robotic device to move the camera corresponding to the change of the camera position and/or angle.

The graphic layer may include one camera symbol for each spatial two-dimensional plane.

The graphic layer may further include a frame that indicates relative to the camera icon in the display the corresponding specific range in the spatial two-dimensional plane within which the camera can move.

The display can be a touch-screen on which the camera symbol/camera icon position can be changed by touching the screen. The contact may be direct.

A method for controlling a camera's position and/or angle with a control mean that includes a display, where the camera is mounted on a movable mechanical device, wherein the method comprises
displaying on the display a real-time image view recorded by the camera,
placing a graphic layer over the image composition on the display that includes at least one camera symbol where the camera symbol position and/or angle of the display corresponds to the position and/or angle of the camera,
changing the camera's position and/or angle corresponding to a change of the camera symbols position and/or angle of the display.

The mechanical moving device may be a robot device adapted to be able to move the camera in all spatial directions and angles within a certain range.

The method may further comprise:
generating signals on the basis of the change of the camera symbol position and/or angle
sending signals to the robot assembly, and
interpreting the signals as instructions to the robotic device to move the camera corresponding to the change of the camera position and/or angle.

The graphic layer may include one camera symbol for each spatial two-dimensional plane.

The graphic layer may further include a frame that indicates relative to the camera symbol of the corresponding specific range in the spatial two-dimensional plane within which the camera can move.

The display can be a touch-screen on which the camera symbol's/icon's position can be changed by directly touching the display.

The present embodiment has many advantages. A non-exhaustive list is as follows:

The present embodiments may have an advantage in that they lead to a more efficient production of broadcast content.

Another advantage of the present embodiment is that staffing may be decreased and that production will be cheaper.

### BRIEF DESCRIPTION OF THE DRAWINGS

The following detailed description of the present embodiments is accompanied by drawings to make it easily understandable:

FIG. 1 is a diagram that illustrates which and how different elements for example may be involved in one embodiment, and how elements can interact with each other,

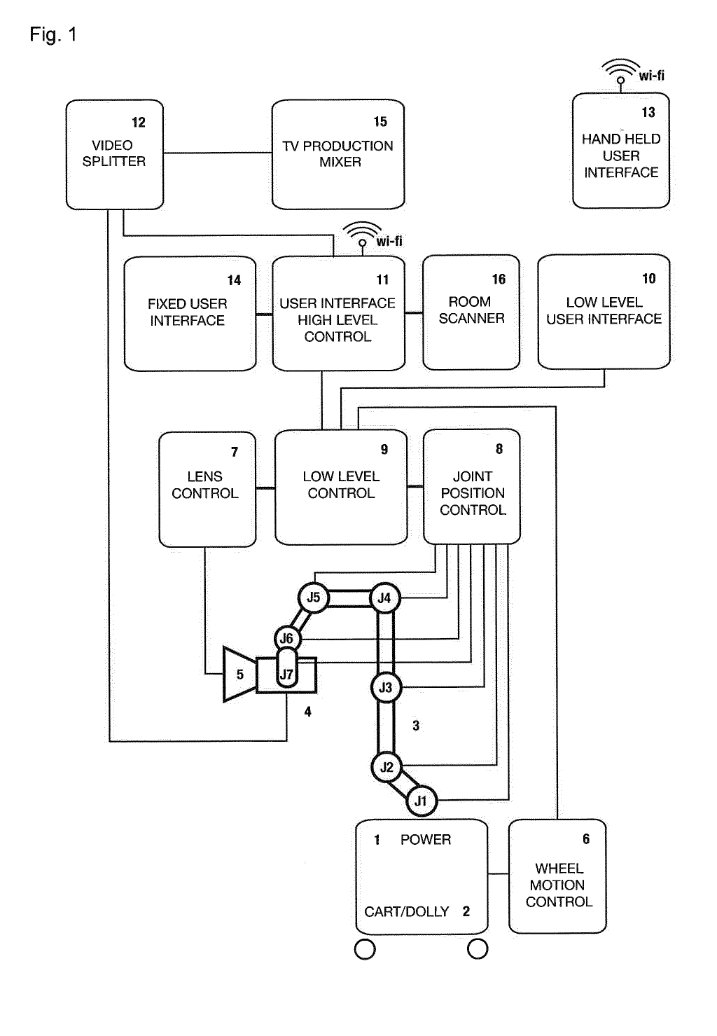

FIG. 2 is a screenshot that shows an example of a user interface with camera control symbols projected onto a camera image,

FIG. 3 shows the display in FIG. 2, together with a corresponding camera position shown from three different angles,

FIG. 4 shows a screenshot with an example of how the view of the camera image is shifted by changing the camera icon positions relative to the display in FIG. 2,

FIG. 5 shows the display in FIG. 4 together with a corresponding shifted camera position shown from three different angles.

### DETAILED DESCRIPTION OF AN EXAMPLE EMBODIMENT

In the following the present embodiments will be discussed, and examples are presented with reference to the attached figures. The reference numbers that will be used is of the form (xy), where x is the figure number, and y is the numeral in the figure.

The present embodiments relate to a control device having a display adapted to control a camera's position and/or angle, where the camera is adapted to be mounted on a mechanically movable device. The control device constitutes an intuitive touch-screen control system with a multi-touch user interface for movement with film, video and still cameras over three axes, X, Y, Z, with a mechanical moving device, for example an industrial robot.

The interface consists of a graphical layer overlaid on the incoming video/picture signal from the camera. This layer consists of all the control functions in which all the spatial three-dimensional planes, defined by the in between perpendicular axes X, Y, Z, are visually presented within the frame. In the figures, a circle is used as the example, but a person skilled in the art understands that the frame may be formed as any other suitable geometric shape, such as a square or a triangle. This frame corresponds to a camera robot's physical workspace in the respective plane. The control is triggered by the movement of the camera icons in the graphical layer, wherein the respective symbols represent the camera as seen respectively from above, from the side and from behind. With movement of the symbols, signals are sent to the camera robot, which moves the actual camera position accordingly. The image view captured by the camera, and that lies beneath the graphical layer in the interface, also changes as a consequence of the camera movement.

All positions can be stored and retrieved in production. The robotic arm can thus be remotely programmed and operated from other locations in the world over the internet, fiber or through other devices of communication.

The inventor has realized that an industrial robot arm can provide new opportunities in remote television production, and produce less static image production. Entrances and dynamic crane/jib movements can be made in a confined space and without the physical presence of a camera operator/photographer. A typical industrial robot arm radius is so large that one can go from a dense image (close-up) out to an overview.

In the present embodiment the arm of the industrial robot can, as already indicated, be controlled directly from a multi-touch screen/display which can be wirelessly connected to a communication network through for example Wi-Fi, (1.13), or via a touch display in the control room (direction), or remotely over the network from another place (1.14).

The camera is mounted on the robot arm and the camera's various positions and views can be run and modified directly, without delay with touch functions on the screen/display.

When an operator has made/set a desired composition for the camera to take a picture of, this may in one embodiment of the invention be stored in a database connected to the system. These cutouts/images may appear on the preset level (default level) as small images/buttons on the screen/display where they can be selected and played.

If one puts two selected settings/images together, it is possible to get a new image. This new image represents run/movement between the two options/settings. These are stored as a single run. These run/settings can be saved as a preset for a TV program. The system can store a large amount of setups that can be recalled for the various productions.

The radius of movement of the robotic arm enables camera movement in all spatial (X, Y, Z) directions.

The arm the camera is mounted on may be a small collaborative robot arm, a type description that defines robots that do not require a blocked off area in its working radius. This is for example described in the “ISO standard for collaborative robots 10218-1:2006”.

The camera robot can thus be used in any television production contexts, without the need for safety zones around their workspace. This type of robots senses any resistance and that something is in the way of their movement and puts itself in a safe mode if it senses resistance or that something is in the direction of movement. This means that the robot can operate in any environment close to the people in the TV production. The robot also has a “recall” or “guide cam” function, which enables one to physically and manually move the camera into the desired position, save the position and then move the camera to a new position for storage.

Present embodiments comprises of a high-level control system and a low-level control system. A high-level control system includes a high-level control interface with a graphical front interface displayed to the user, and conveys the various commands from the user's multi-touch display to low-level control of the robot's joints.

The high-level control interface can set the camera's coordinates, positions, speed, acceleration and deceleration of the low-level control system. The high-level control interface tells predominantly constantly where the camera is located, while the low-level control system calculates which joint(s) that need to move the camera to get the desired position at any given time, and use the correct paths defined by the positions of the camera symbols and movements of these multi-touch display in the high-level control system.

All positions can also have been stored in the high-level control system.

As already indicated, the present embodiments thus provides an intuitive high-level interface where all movement controls and the various options lays as separate graphic layer on the display (3.5) of the direct incoming video/picture signal from the camera (3.4).

The camera position is graphically portrayed by one or more camera symbols within a frame on the display (3.6). This frame corresponds to the camera placement with the proportional range and radius of the robotic arm (3.6).

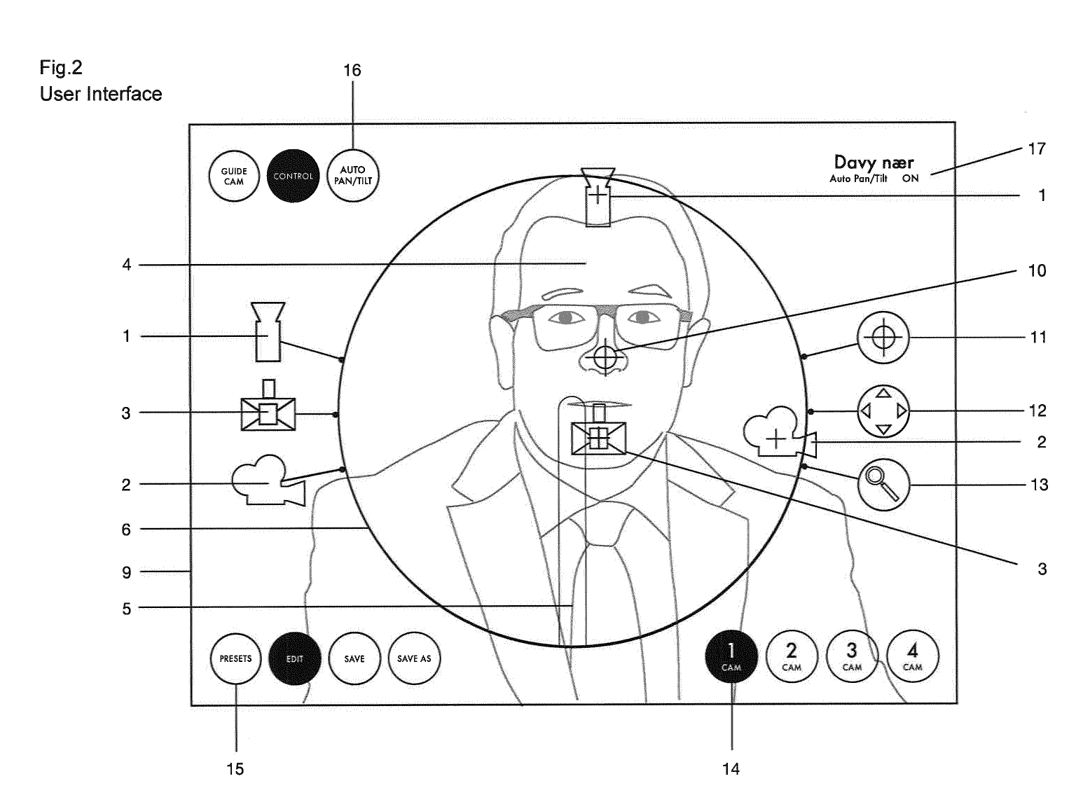

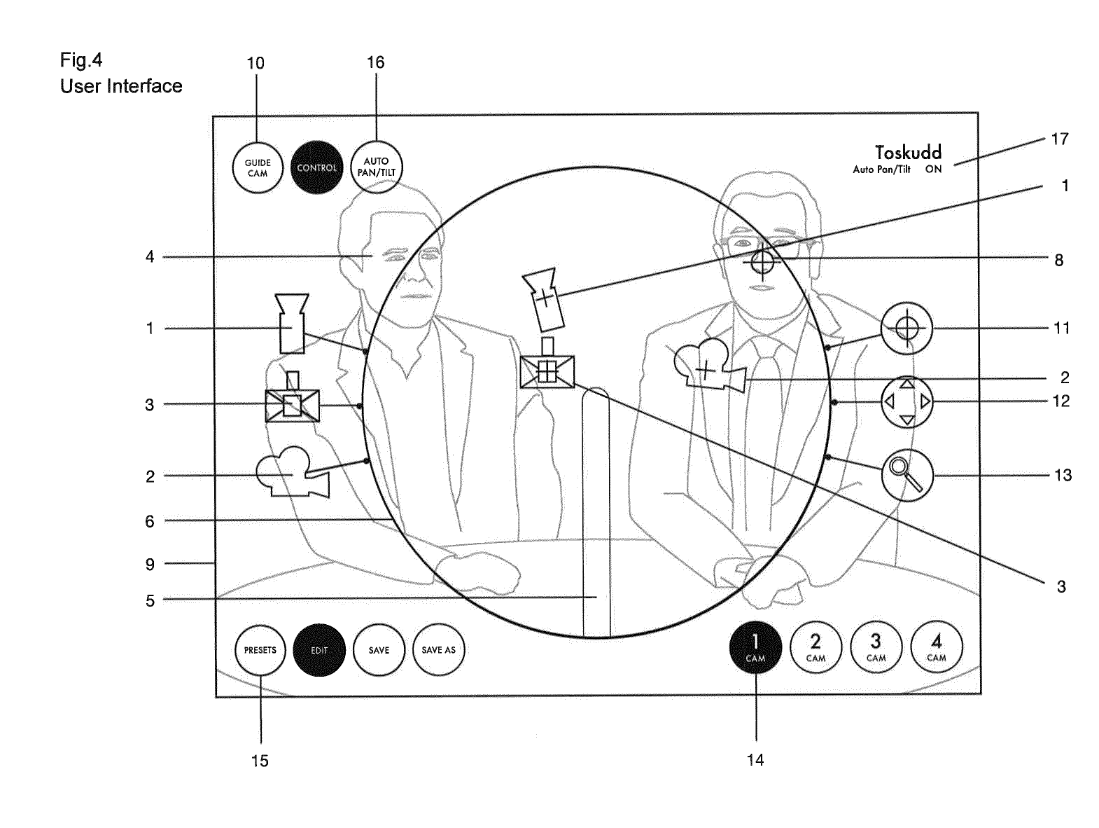

The camera's movement possibilities and position of the respective two-dimensional plane in XYZ, can be seen with the graphic camera symbols, such as the example shown in FIGS. 2-5, with camera symbols that represents the camera position respectively seen from the top, side and from behind, in the same picture in the circle (3 1, 3.2, 3.3).

All camera icons can be moved by an operator, who with a finger, pointing device, etc. touches the icon on the display and points/moves it to the desired position in the circle. The robot responds immediately to the symbol being moved, and the displacement/movement is seen in the underlying incoming camera signal. The graphic camera symbols at any given time represent the camera position in addition to tilt and pan within the range.

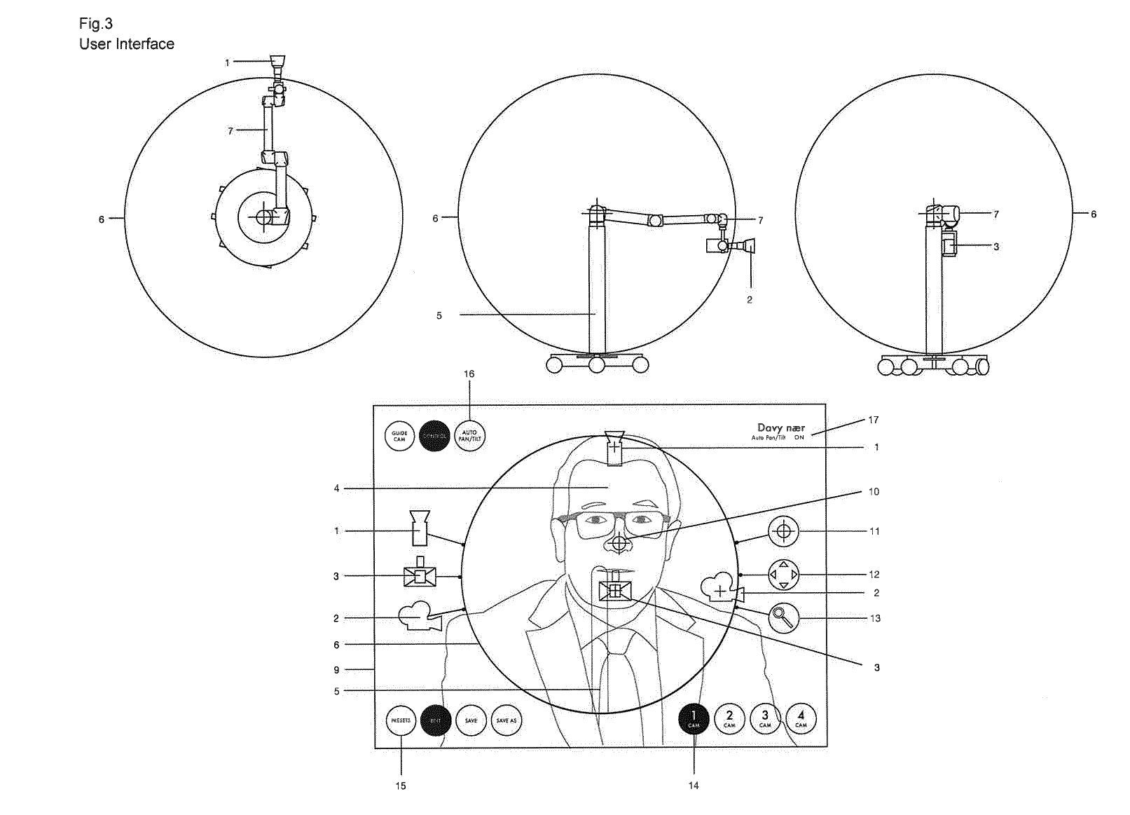

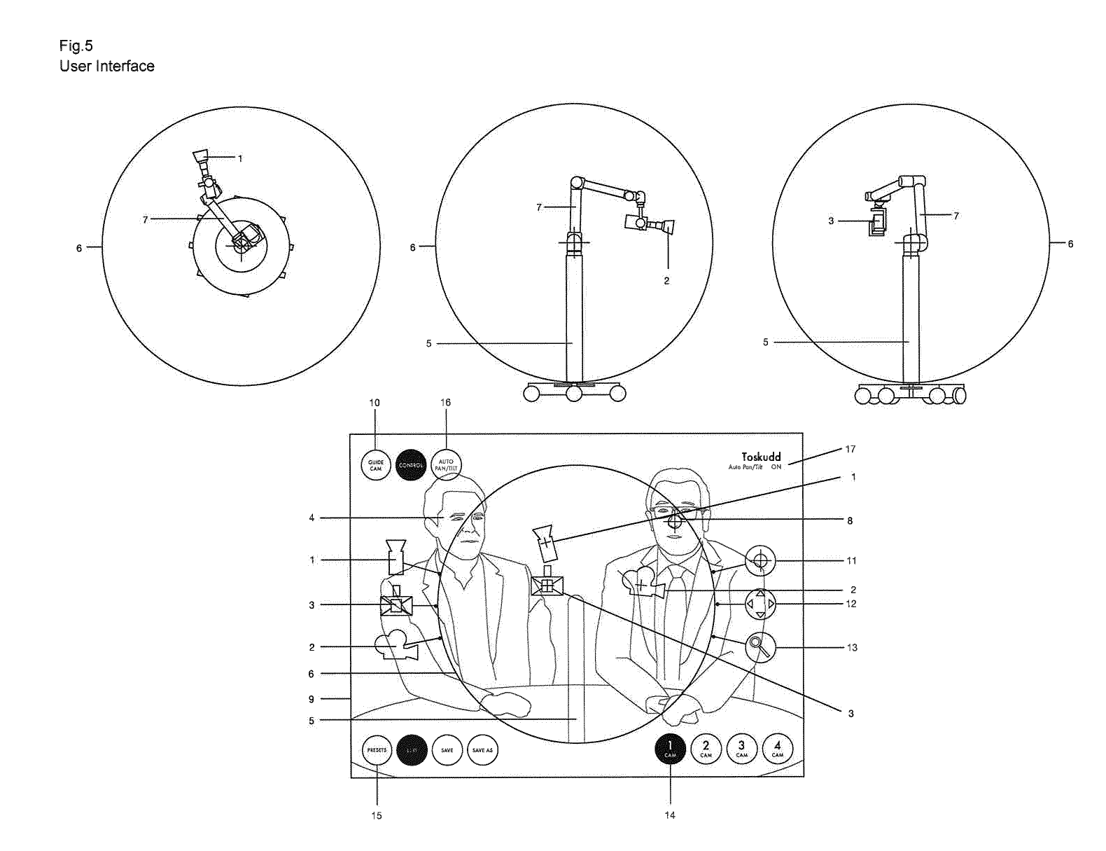

The changes between FIGS. 3 and 5 show an example of how an operator can move the three camera icons on the display and in what changes this results in. The camera icon seen from above (3.1) is initially positioned at the forefront of the outer edge of the circle, and the image view thus shows a close-up of a person. It is also indicated in the upper part of FIG. 3 that the robot arm is consequently in a forward-stretched position. In FIG. 5, the camera icon seen from above (5.1) is shifted somewhat backwards. The camera icon seen from the side (5.2) is thus also moved closer to the center of the circle, as these two symbols have one axis in common. As also shown in FIG. 5, the camera icon seen from above (5.1) is rotated a few degrees to the left. The camera icon seen from behind (5.3) is shifted somewhat to the left of the circle relative to the position (3.5) in FIG. 5. In the upper part of FIG. 5 it is shown from three angles how the robot has changed the camera's position corresponding to the movement of the camera symbols. As one can see the camera's actual position is retracted and moved somewhat to the left, in addition the camera is panned to the left. As a result of these movements the image view recorded by the camera has changed. In FIG. 5 it is indicated that the image on the display now shows two people in the same view.

According to one embodiment, multiple camera symbols may be moved simultaneously. Each symbol constantly related to its own axis and axis which is common for all the symbols. For example if the camera icon seen from the side (2.2) is moved from a position straight up from the bottom of the circle's radius to the top of the circle's radius, the axis with the camera icon seen from behind (2.3) will follow the movement of the camera seen from the side, as they share the vertical axis.

The camera symbols also show pan and tilt position of the camera (1.6 and 1.7).

The three camera/axis symbols can have their own identity color to help distinguish them, such as red, blue and green.

According to one embodiment, the pan, tilt and roll functions can be activated by the camera symbols for example on the left side of the circle is held, and on activation switches to its active color. The symbol is then moved up or down, clockwise or counterclockwise to tilt, pane or roll.

Pan and tilt can also be controlled by a separate function button (2.12) designed for example as a joystick, for example on the right side of the circle. The joystick can also be located at any other position, e.g. on the left side, the bottom or top of the circle.

Should there of location reasons be camera symbols located above the other, one may by pressing/activating the buttons/symbols on the left side of the circle decide which axis you want to control, and then control the axis which is selected (3.18, 3.19. 3.20).

The robot arm can be attached to a column, either with movement options or static to the floor.

The columns height should be adapted to the robot arms workspace and the camera's size and weight. The robots attachment mean and the column is in itself a blind spot where the camera cannot move. The robotic arm's/camera's limited blind spot (the robot's own body) is highlighted in the circle (3.5). When the camera size is defined in the user interface, the robot cannot run into itself with the camera, as this area preferably is programmed in as a blind spot.

The circle's right edge features the focus, pan/tilt and zoom functions. Although the figure shows that the feature is located on the right these can also be located on the left side, top or bottom of the circle.

When an operator has made/set an image view, this can be stored in the system database.

These views/images can be shown in a preset level as smaller images, where they can be selected and played.

According to one embodiment, alignment of two selected settings leads to the creation of a run/movement between the two options which again can be saved as a separate movement. These movements/settings can be saved as a layout for a program. The system can store a large amount of setups that can be recalled to the various productions. The robot arm can be attached to a column, either with driving opportunities or static against the floor or ceiling.

The description above indicates different examples for illustrative purposes. A person skilled in the art will be able to realize a variation of different symbol combinations, symbol design and robotic mechanisms, all within the present embodiment area.

It must be emphasized that the terminology “constitute/constitutes” and “comprise/comprises” as used in this specification is chosen to specify the presence of stated features, numbers, steps or components, but does not preclude the presence or addition of one or more other functions, numbers, steps, components or groups thereof. It should also be noted that the word “a” or “an” preceding an element does not exclude the presence of a plurality thereof.

It should also be emphasized that the steps of the method defined in the appended claims may, without going beyond the embodiments herein, performed in a different order than the order they appear in the following claims.

1. A control device having a display adapted to control at least one of a position and angle of a camera, where the camera is adjusted to be mounted on a mechanically movable device, the control device comprising:
a real-time image viewed on a display recorded by the camera a graphical layer overlaid on the image on the display including at least one camera symbol where at least one of the position and angle of the at least one camera symbol on the display corresponds to at least one position and angle of the camera;
a change of the at least one position and angle of the at least one camera symbol on the display activating a corresponding change of the at least one position and angle of the camera;
the mechanically movable device being a robotic device configured to move the camera in all spatial directions and angles within a certain range; and
the graphical layer including one camera symbol for each spatial two-dimensional plane.

2. The control device according to claim 1, wherein the change of the at least one camera symbol position and angle generates signals of a control device which is sent to the robotic device and interpreted as instructions by the robot device to move the camera, correspondingly changing at least one of the camera position and angle.

3. The control device according to claim 1, wherein the graphical layer further comprises a frame that indicates relative to the cameras icon in the display the corresponding specific range in the spatial two-dimensional plane within which the camera can move.

4. The control device according to claim 1, wherein the display is a touch display upon which the position of the at least one camera symbol can be altered by touching the display.

5. A method for controlling at least one of a camera position and an angle with a control device that includes a display, the camera being mounted on a movable mechanical device, the method comprising:
displaying on the display a real-time image view recorded by the camera;
placing a graphic layer over the image composition on the display that includes at least one camera image where the at least one camera symbol position and angle of the display corresponds to the at least one camera position and angle;
changing the at least one camera position and angle corresponding to a change of the at least one camera symbol's position and angle of the display;
the mechanical moving device being a robotic device adapted to move the camera in all spatial directions and angles within a certain range; and
the graphical layer comprising one camera symbol for each spatial two-dimensional plane.

6. The method according to claim 5, further comprising:
generating signals on the basis of the change of at least one of the camera symbol's position and angle;
sending the signals to the robot device; and
interpreting the signals as instructions to the robotic device to move the camera corresponding to the change of the at least one of camera position and angle.

7. The method according to claim 5, wherein the graphical layer further comprises a frame that indicates relative to the camera symbols of the display the corresponding specific range in the spatial two-dimensional plane within which the camera can move.

8. The method according to claim 5, wherein the display is a touch-screen upon which the positions of the at least one camera symbol can be changed by touching the display.
